(19) United States
(12) Patent Application Publication
(10) Pub. No.: US 2026/0253020 A1
(43) Pub. Date: Aug. 27, 2026

(54) INFORMATION PROCESSING SYSTEM, INFORMATION PROCESSING DEVICE, INFORMATION PROCESSING METHOD, AND PROGRAM

(71) Applicant: AERONEXT INC., Tokyo (JP)

(72) Inventors: Shuji KAWAI, Tokyo (JP); Tadanari HIGUCHI, Gifu (JP); Keisuke TOJI, Tokyo (JP); Takuya HORI, Tokyo (JP)

(21) Appl. No.: 18/879,249

(22) PCT Filed: Jun. 28, 2023
(86) PCT No.: PCT/JP2023/024022

§ 371 Date: Dec. 27, 2024

(30) Foreign Application Priority Data
Jun. 30, 2022 (JP) 2022-105546

(51) Int. Cl. G06Q 10/083

(52) U.S. Cl. CPC G06Q 10/083

(57) ABSTRACT

An information processing system includes a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

### FIELD

The present invention relates to an information processing system, an information processing device, an information processing method, and a program.

### BACKGROUND

In recent years, package delivery services have come to use more and more kinds of delivery means, and technologies have been developed to handle a variety of delivery means. For example, Patent Literature 1 discloses a logistics management system that manages information about a logistics network and changes operation plans of a circular service circulating in an area on the basis of such information.

### CITATION LIST

### Patent Literature

Patent Literature 1: Japanese Patent Application Laid-open No. 2020-52525

### SUMMARY

### Technical Problem

As such delivery means, delivery of packages on a mobile body that performs transportation in a passenger and freight integrated way, such as a train or a bus, has been considered. However, the shortage of manpower in package delivery has become an issue, and more efficient delivery of packages by mobile bodies, such as those performing transportation in the passenger and freight integrated way, has also been demanded.

The present invention has been made in view of the above problem, and an object of the present invention is to provide a novel and improved information processing system that makes the package delivery efficient.

### Solution to Problem

In order to solve the above problem, one aspect of the present invention provides an information processing system including a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

Moreover, in order to solve the above problem, another aspect of the present invention provides an information processing device including a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

In addition, in order to solve the above problem, still another aspect of the present invention provides an information processing method to be performed by a computer, the information processing method including notifying a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

Furthermore, in order to solve the above problem, yet another aspect of the present invention provides a program that causes a computer to function as a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

### Advantageous Effects of Invention

As described above, the present invention can make the package delivery efficient.

### BRIEF DESCRIPTION OF DRAWINGS

FIG. 1 is an explanatory diagram of an overview of an information processing system according to the present invention.

FIG. 2 is an image diagram of one example of package delivery in an information processing system according to the present invention.

FIG. 3 is an explanatory diagram illustrating an internal structure of a delivery person's terminal 10.

FIG. 4 is an explanatory diagram illustrating an internal structure of a service provider's terminal 20.

FIG. 5 is an explanatory diagram illustrating an internal structure of a server 30.

FIG. 6 is an explanatory diagram for describing an example of a procedure of operation processing by the server 30 according to the present embodiment.

FIG. 7 is an explanatory diagram for describing an example of a hardware configuration of the server 30 according to the present embodiment.

### DESCRIPTION OF EMBODIMENTS

The contents of embodiments of the present invention will be listed and described. An information processing system and the like according to the embodiments of the present invention include the following configurations.

### Item 1

An information processing system including a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

### Item 2

The information processing system according to item 1, further including a control unit that sets the candidate for the service provider, as the service provider when the candidate for the service provider responds to the recruitment of the service provider, in which the communication unit notifies setting information about setting of the service provider to a delivery person's terminal used by the delivery person.

### Item 3

The information processing system according to item 2, in which
the control unit generates instruction information that is information to instruct the delivery person to handle the package, based on whether the candidate for the service provider responds to the recruitment of the service provider, and
the communication unit notifies the delivery person's terminal of the instruction information.

### Item 4

The information processing system according to item 3, in which the instruction information includes information to instruct the delivery person to get on the mobile body together with the package.

### Item 5

The information processing system according to item 3, in which the instruction information includes information to instruct the delivery person to unload the package from the mobile body.

### Item 6

The information processing system according to item 2 or 3, in which the communication unit receives a service provider setting request that is a notification to request setting of the service provider from the delivery person's terminal.

### Item 7

The information processing system according to item 1 or 2, in which the mobile body is a mobile body that operates on a regular schedule.

### Item 8

The information processing system according to item 7, in which the control unit determines a time when the service provider provides a service, based on a determination of a service number of the mobile body that delivers the package.

### Item 9

The information processing system according to item 7, in which the communication unit receives from the delivery person's terminal, information to instruct the service number of the mobile body that delivers the package.

### Item 10

The information processing system according to item 1 or 2, in which the communication unit issues notification of the recruitment of the service provider in charge of temporarily receiving the package that is delivered by the mobile body outside the mobile body and in charge of delivering the package by getting on the mobile body.

### Item 11

The information processing system according to item 10, in which the communication unit issues notification of the recruitment of the service provider in charge of temporarily receiving the package that is delivered by the mobile body outside the mobile body and in charge of loading the package into an unmanned vehicle after the delivery by the mobile body.

### Item 12

The information processing system according to item 1 or 2, in which the package loaded in the mobile body is accommodated in an accommodation box installed in the mobile body.

### Item 13

The information processing system according to item 1 or 2, in which the communication unit issues notification of the recruitment of the service provider in charge of temporarily receiving the package from the delivery person or the service provider inside the mobile body or temporarily receiving the package loaded in the mobile body by getting on the mobile body.

### Item 14

The information processing system according to item 1 or 2, in which the communication unit notifies the service provider's terminal used by the candidate for the service provider who is on the mobile body, of the recruitment of the service provider in charge of at least any of temporarily receiving the package from the delivery person inside the mobile body and temporarily receiving the package loaded in the mobile body.

### Item 15

The information processing system according to item 1 or 2, in which the communication unit issues notification of the recruitment of the service provider in charge of at least any of temporarily receiving the package outside the mobile body, temporarily receiving the package from the delivery person inside the mobile body, temporarily receiving the package loaded in the mobile body, and temporarily receiving the package from the delivery person who is inside the mobile body, and in charge of unloading the package from the mobile body.

### Item 16

The information processing system according to item 15, in which the communication unit issues notification of the recruitment of the service provider in charge of unloading the package from the mobile body and in charge of loading the package into an unmanned vehicle.

### Item 17

An information processing device including a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

### Item 18

An information processing method to be performed by a computer, the information processing method including notifying a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

### Item 19

A program that causes a computer to function as a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

Preferred embodiments of the present invention will hereinafter be described in detail with reference to the accompanying drawings. In the present specification and drawings, duplicate explanations of components having substantially identical functional configuration will be omitted by applying the same reference signs thereto.

In the present specification and the drawings, a plurality of components with substantially the same functional configuration may be distinguished by the same reference sign followed by different numerals or alphabets. However, when there is no particular need to distinguish between the components that have substantially the same functional configuration, just the same reference sign is given to each of the components.

### 1. Overview of Information Processing System According to One Embodiment of Present Disclosure

The overview of the information processing system that can make the package delivery efficient according to the embodiment of the present invention will be described first.

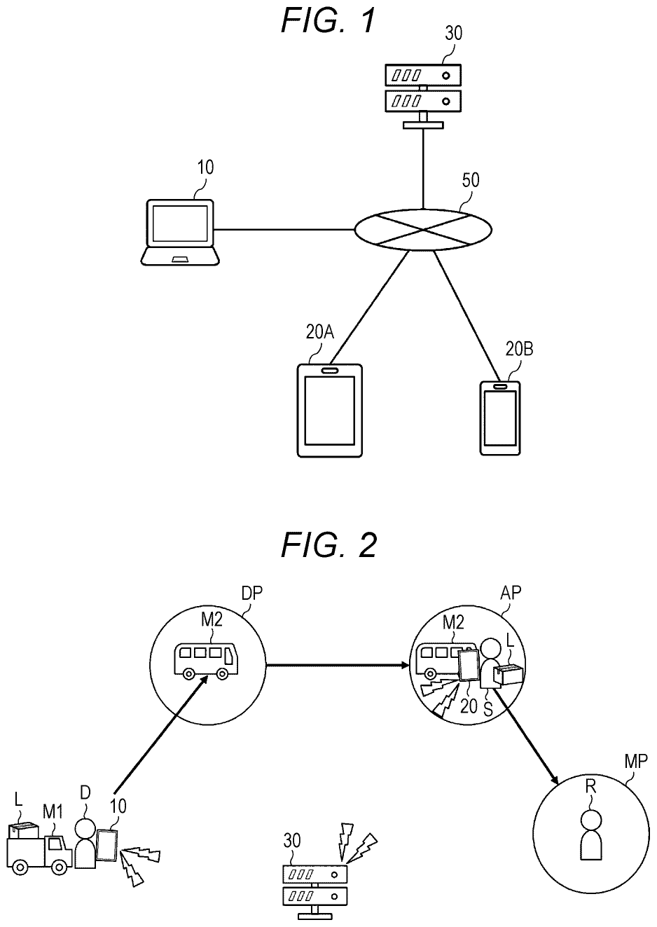

FIG. 1 is an explanatory diagram of an overview of the information processing system according to the present invention. As illustrated in FIG. 1, the information processing system according to the present invention includes a delivery person's terminal 10, a service provider's terminal 20, a server 30, and a network 50. As illustrated in FIG. 1, the delivery person's terminal 10, the service provider's terminal 20, and the server 30 are configured to be able to communicate with each other via the network 50.

The delivery person's terminal 10 is an information processing terminal used by a delivery person who delivers (delivers and collects) packages. The delivery person's terminal 10 receives information from the server 30 regarding the packages to be delivered by the delivery person who uses the delivery person's terminal 10.

In the delivery of packages, the delivery of which is handled by delivery persons, the delivery means may include the use of a passenger and freight integrated mobile body, which is a mobile body that performs transportation in the passenger and freight integrated way. In such a case, the services related to the delivery by the passenger and freight integrated mobile body can also be handled by service providers who contract for such services as a one-off job. Such service providers are also commonly referred to as so-called gig workers. The delivery person's terminal 10 transmits to the server 30, a service provider setting request that is a notification requesting the setting of a service provider. The delivery person's terminal 10 also receives setting information regarding the setting of the service provider from the server 30.

The delivery person's terminal 10 also receives instruction information, which is information to instruct the delivery person to handle the package, from the server 30. The instruction information is, for example, information that instructs to get on the passenger and freight integrated mobile body together with the package, or information that instructs to unload the package from the passenger and freight integrated mobile body.

The service provider's terminal 20 is an information processing terminal used by a candidate for the service provider or the service provider. The service provider's terminal 20 receives a notification of recruitment for the service provider in charge of a service related to the delivery of the package by the passenger and freight integrated mobile body. The candidate for the service provider may view the above-described notification of the recruitment by operating the service provider's terminal 20.

Furthermore, the service provider can respond to (apply for) the above-described recruitment by operating the service provider's terminal 20. When the candidate for the service provider performs an operation to respond to the recruitment at the delivery person's terminal 10, the service provider's terminal 20 notifies the server 30 that the candidate for the service provider has responded to the recruitment.

The delivery person's terminal 10 and the service provider's terminal 20 are, for example, information processing terminals such as a personal computer (PC), a tablet terminal, a smartphone, a cellular phone, a personal handy-phone system (PHS), and a personal digital assistant (PDA). In the example illustrated in FIG. 1, the delivery person's terminal 10 is a PC, a service provider's terminal 20A is a tablet terminal, and a service provider's terminal 20B is a smartphone.

The server 30 is an example of an information processing device that, in the case where the delivery means of the package to be handled by the delivery person includes the passenger and freight integrated mobile body, notifies the service provider's terminal 20 of the recruitment of the service provider in charge of a service related to the delivery by the passenger and freight integrated mobile body. For example, the server 30 may be a general-purpose computer, such as a workstation or PC, or may be a cloud server.

Upon the reception of the service provider setting request from the delivery person's terminal 10, the server 30 transmits the notification of the recruitment of the service provider to the service provider's terminal 20. The server 30 can generate notifications of recruitment of various kinds of service providers in response to the service provider setting request. Details pertaining to the notifications of the recruitment of the service providers will be discussed below.

The server 30 can also generate the notification of the recruitment of the service provider according to a delivery plan for the package delivery. The delivery plan includes, for example, information about the means and routes of package delivery, etc. The server 30 may also determine a delivery slot for the delivery of packages by the delivery person or an unmanned vehicle that delivers the packages according to the delivery plan. In this specification, the delivery slot corresponds to each of time bands sectioned by a predetermined length of time in which packages can be delivered by each delivery means, such as a delivery person or an unmanned vehicle. Once the delivery slot for the package delivery is determined, the package is delivered by each delivery means in the time band corresponding to the delivery slot.

The server 30 also sets the candidate for the service provider as the service provider when the candidate for the service provider responds to the recruitment of the service provider. The server 30 also notifies the delivery person's terminal 10 of the setting information of the service provider.

Furthermore, the server 30 generates instruction information, which is information to instruct the delivery person to handle the package, based on whether the candidate for the service provider responds to the recruitment of the service provider. The server 30 then notifies the delivery person's terminal 10 of the generated instruction information.

The network 50 is a wired or wireless transmission path for information transmitted from devices connected to the network 50. For example, the network 50 may include a public network such as the Internet, a telephone network, or a satellite communication network, various local area networks (LANs) including Ethernet (registered trademark), or a wide area network (WAN). The network 50 may also include a leased line network such as Internet protocol-virtual private network (IP-VPN).

FIG. 2 is an image diagram of one example of package delivery in the information processing system according to the present invention. In the example illustrated in FIG. 2, a package L requested by a client R, who requests the delivery of the package L, is delivered by a delivery person D and a service provider S.

The server 30 notifies the service provider's terminal 20 of the recruitment of the service provider in charge of the service related to the delivery by a passenger and freight integrated mobile body M2. In the example illustrated in FIG. 2, the server 30 notifies the service provider's terminal 20 of the recruitment of the service provider in charge of temporarily receiving the package L from the delivery person D in the passenger and freight integrated mobile body M2 and passing the package L to the client R.

The server 30 sets the candidate for the service provider as the service provider S when the candidate for the service provider who uses the service provider's terminal 20 responds to the recruitment of the service provider.

The delivery person D delivers the package L by a mobile body M1 to a departure point DP of the passenger and freight integrated mobile body M2. Then, at the departure point DP, the delivery person D gets on the passenger and freight integrated mobile body M2 together with the package L and delivers the package L to an arrival point AP of the passenger and freight integrated mobile body M2. The service provider S temporarily receives the package L from the delivery person D who is inside the passenger and freight integrated mobile body M2 at the arrival point AP of the passenger and freight integrated mobile body M2 and passes the package L to the client R at a delivery point MP with the client R. At this time, the delivery person D may remain in the passenger and freight integrated mobile body M2 and deliver another package to a different client R at another arrival point, or may get off the passenger and freight integrated mobile body M2 at the arrival point AP or another arrival point and go on to deliver the next package.

The delivery point MP may be any location, for example, a landmark such as a bus stop, a station, or other terminal (including stops), a building, or a parking lot.

The mobile body M1 is a mobile body used as the delivery means of the delivery person D. For example, the mobile body M1 may be a manned mobile body such as a vehicle that moves in a land route, an aircraft that flies in an air route, or a ship that moves on water in a sea route, a river route, and the like.

In the example illustrated FIG. 2, the delivery person D delivers the package L by the mobile body MI to the departure point DP of the passenger and freight integrated mobile body M2; however, the delivery means of the package L is not limited to this. For example, the mobile body M1 that is the delivery means of the package L may be an unmanned vehicle 40 that moves based on autonomous control using input information about positions, for example, two positions of a start point (for example, a delivery start position of the package L or a moving start position of the unmanned vehicle 40) and an end point (for example, a pick-up position of the package L) where the package delivery without the delivery person D is possible, or three or more positions of further including a relay point (for example, in a case of delivery with collection of the package L, a collection position of the package L) or a return point (for example, the same position as the moving start position of the unmanned vehicle 40, or a different stand-by position, etc.).

The mobile body M1 may be an unmanned vehicle that moves by a remote operation using operation information remotely operated and input by a manager who manages the unmanned vehicle. The unmanned vehicle may be, for example, a drone that moves based on autonomous control, an unmanned aerial vehicle (UAV) that moves by a remote operation by a manager, a vehicle that moves in a land route, such as an unmanned ground vehicle (UGV), or a ship that moves on water in a sea route, a river route, and the like. The unmanned vehicle may alternatively be a mobile body that can move in at least two or more routes of a land route, a water route, and an air route.

The passenger and freight integrated mobile body M2 is a mobile body that performs transportation in the passenger and freight integrated way and is included in the delivery means of the package L. For example, the passenger and freight integrated mobile body M2 may be a mobile body such as a vehicle that moves in a land route, for example, a bus, a train, a taxi, a cable car, or the like, an aircraft that flies in an air route, or a ship that moves on water in a sea route, a river route, and the like. The passenger and freight integrated mobile body M2 may also be a mobile body that operates on a regular schedule.

The package L may be delivered by a plurality of the delivery persons D and the service providers S. For example, the package L delivered by the delivery person D to the departure point DP may be temporarily received by a service provider S different from the service provider S illustrated in FIG. 2 inside the passenger and freight integrated mobile body M2, and then delivered to the arrival point AP, where the delivered package is handed over to the service provider S illustrated in FIG. 2. The service provider who receives the package L inside the passenger and freight integrated mobile body M2 may get off at the arrival point AP and continue the delivery to the delivery destination. The package may be handed over in such a way that the delivery person D puts the package in a package housing unit such as a keeping box provided in the passenger and freight integrated mobile body M2 or a baggage space of the passenger and freight integrated mobile body M2 at the departure point DP and leaves the passenger and freight integrated mobile body M2, and the service provider S takes out the package from the housing unit at the arrival point AP. Alternatively, the package L may be handed over to the service provider S from the delivery person D instead of from the housing unit, and the package may be passed on to another delivery person or another service provider.

The overview of the information processing system according to the embodiment of the present invention has been described above. Next, an example of the functional configuration of the delivery person's terminal 10 is described.

### 2. Example of Functional Configuration in Present Embodiment

### <2-1. Example of Functional Configuration of Delivery Person's Terminal 10>

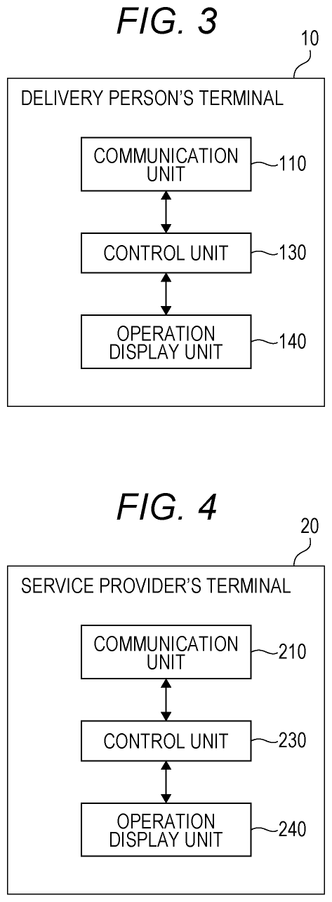

FIG. 3 is an explanatory diagram illustrating an internal structure of the delivery person's terminal 10. As illustrated in FIG. 3, the delivery person's terminal 10 includes a communication unit 110, a control unit 130, and an operation display unit 140.

### (Communication Unit)

The communication unit 110 communicates with and connects to the server 30 via the network 50 and transmits and receives data. For example, the communication unit 110 transmits to the server 30, the service provider setting request that is a notification requesting the setting of the service provider related to the delivery of the package L. The service provider setting request may include information such as the content and the time of the service that the delivery person D hopes to be provided by the service provider S. In the case where the package L is delivered by the passenger and freight integrated mobile body M2 that operates on a regular schedule, the service provider setting request may include information to designate the type or the service number of the passenger and freight integrated mobile body M2 (such as route information, departure time information, departure point information, or arrival point information).

The communication unit 110 also receives from the server 30, the setting information regarding the setting of the service provider S who is in charge of the service related to the delivery by the passenger and freight integrated mobile body M2. The delivery person's terminal 10 also receives from the server 30, the instruction information, which is information to instruct the delivery person D to handle the package L.

The communication unit 110 may also transmit positional information indicating the position of the delivery person's terminal 10 to the server 30. The positional information may be, for example, positioning information (information about longitude, latitude, and altitude) obtained by a global navigation satellite system (GNSS). The positional information may also be positional information (for example, current address) input by the delivery person D on the operation display unit 140.

### (Control Unit)

The control unit 130 controls the overall operation of the delivery person's terminal 10. The control unit 130 also causes the operation display unit 140 to display the setting information and the instruction information that are received from the server 30 by the communication unit 110.

### (Operation Display Unit)

The operation display unit 140 encompasses a function as an operation unit, which is a structure that the delivery person D operates to input an instruction or information into the delivery person's terminal 10, and a function as a display unit, which displays various kinds of information according to the control by the control unit 130.

For example, the communication unit 110 can transmit to the server 30, the service provider setting request regarding the delivery of the package L on the basis of the operation of the operation display unit 140 by the delivery person D. By operating the operation display unit 140, the delivery person D can select the content, the time, etc., of the service that the delivery person D hopes to be provided by the service provider S and that is included in the service provider setting request. When the delivery person D can select the service that the delivery person D hopes to be provided by the service provider S, the delivery efficiency of the delivery person D increases, thereby improving the efficiency of the delivery of the package L.

The operation display unit 140 displays information such as the setting information and the instruction information transmitted from the server 30 to the communication unit 110.

The function of the operation display unit 140 as an operation unit can be realized, for example, by a touch panel or keyboard. The function as the display unit can be realized by a cathode ray tube (CRT) display device, a liquid crystal display (LCD), or an organic light emitting diode (OLED) device. The function as the display unit and the function as the operation unit may be configured separately.

The delivery person's terminal 10 may be equipped with a microphone, which is not illustrated in FIG. 3, and in this case, the delivery person D may use the microphone to input various kinds of information with his/her voice. The delivery person's terminal 10 may be further equipped with a speaker, which is not illustrated in FIG. 3, and in this case, the delivery person D may check various kinds of information through the voice output from the speaker.

The example of the functional configuration of the delivery person's terminal 10 according to the embodiment of the present invention has been described above. Subsequently, an example of the functional configuration of the service provider's terminal 20 is described.

### <2-2. Example of Functional Configuration of Service Provider's Terminal 20>

FIG. 4 is an explanatory diagram illustrating an internal structure of the service provider's terminal 20. As illustrated in FIG. 4, the service provider's terminal 20 includes a communication unit 210, a control unit 230, and an operation display unit 240.

### (Communication Unit)

The communication unit 210 communicates with and connects to the server 30 via the network 50 and transmits and receives data. The communication unit 210 receives the notification of the recruitment of the service provider in charge of the service related to the delivery of the package L by the passenger and freight integrated mobile body M2.

The communication unit 210 also transmits to the server 30, the information input to the operation display unit 240 as to whether the candidate for the service provider has responded to the recruitment.

The communication unit 210 may also transmit the positional information indicating the position of the service provider's terminal 20 to the server 30.

The communication unit 210 may also transmit to the server 30, information about the passenger and freight integrated mobile body M2 which the candidate for the service provider is on or will get on. The information about the passenger and freight integrated mobile body M2 may be, for example, information such as the point at which the candidate for the service provider got on or will get on the passenger and freight integrated mobile body M2 (for example, the departure point DP illustrated in FIG. 2), the departure time, a point where the candidate for the service provider will get off (for example, the arrival point AP illustrated in FIG. 2), and the arrival time.

### (Control Unit)

The control unit 230 controls the overall operation of the service provider's terminal 20. The control unit 230 also causes the operation display unit 240 to display the setting information and the instruction information that are received from the server 30 by the communication unit 210.

### (Operation Display Unit)

The operation display unit 240 encompasses a function as an operation unit, which is a structure that the candidate for the service provider or the service provider S operates to input an instruction or information into the service provider's terminal 20, and a function as a display unit, which displays various kinds of information according to the control by the control unit 230.

For example, the candidate for the service provider can respond to the notification of the recruitment of the service provider by operating the operation display unit 240. The operation to respond to the notification of the recruitment of the service provider may be, for example, pressing an application button displayed on the operation display unit 240. The service provider S can also notify the server 30 of the start or completion of the determined service by operating the operation display unit 240.

The candidate for the service provider may input the information about the passenger and freight integrated mobile body M2 which the candidate for the service provider is on or will get on by operating the operation display unit 240.

In addition, by operating the operation display unit 240, the candidate for the service provider or the service provider S can view the information about the service that is currently wanted or already determined (for example, the position of the departure point DP, the arrival point AP, or the delivery point MP illustrated in FIG. 2, and the time to get on or off from the passenger and freight integrated mobile body M2).

The function of the operation display unit 240 as an operation unit can be realized, for example, by a touch panel or keyboard. The function as the display unit can be realized by a CRT, a display device, a liquid crystal display (LCD), or an OLED device. The function as the display unit and the function as the operation unit may be configured separately.

The service provider's terminal 20 may be equipped with a microphone, which is not illustrated in FIG. 4, and in this case, the candidate for the service provider or the service provider S may use the microphone to input the execution status regarding the service of the delivery of the package L with his/her voice. The service provider's terminal 20 may be further equipped with a speaker not illustrated in FIG. 4, and in this case, the candidate for the service provider or the service provider S may check various kinds of information by the voice output from the speaker.

The example of the functional configuration of the service provider's terminal 20 according to the embodiment of the present invention has been described above. Next, an example of the functional configuration of the server 30 is described.

### <2-3. Example of Functional Configuration of Server 30>

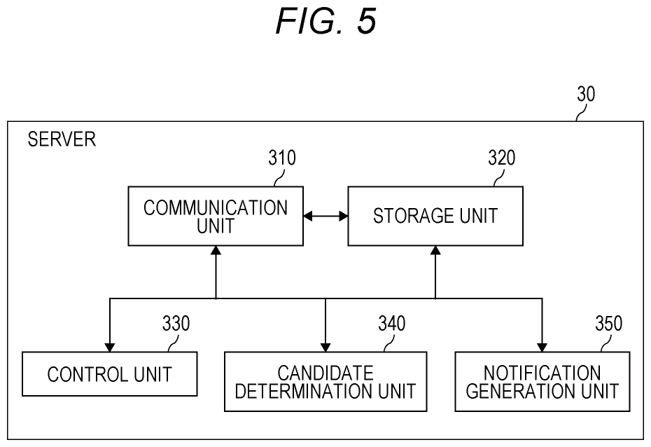

FIG. 5 is an explanatory diagram illustrating an internal structure of the server 30. As illustrated in FIG. 5, the server 30 includes a communication unit 310, a storage unit 320, a control unit 330, a candidate determination unit 340, and a notification generation unit 350.

### (Communication Unit)

The communication unit 310 communicates with the delivery person's terminal 10 and the service provider's terminal 20 via the network 50. The communication unit 310 notifies the delivery person's terminal 10 of the information, thereby notifying the delivery person D who uses the delivery person's terminal 10 of information. The communication unit 310 notifies the service provider's terminal 20 of the information, thereby notifying the service provider S or the candidate for the service provider who uses the service provider's terminal 20 of information.

The communication unit 310 receives the service provider setting request from the delivery person's terminal 10. The communication unit 310 also transmits to the delivery person's terminal 10, the setting information regarding the setting of the service provider S who is in charge of the service related to the delivery by the passenger and freight integrated mobile body M2. The setting information includes, for example, the information as to whether the service provider S is set, the service to be handled by the service provider S, and the like. The communication unit 310 also transmits the instruction information to the delivery person's terminal 10.

In addition, the communication unit 310 transmits the notification of the recruitment of the service provider generated by the notification generation unit 350 to the service provider's terminal 20 in accordance with the control by the control unit 330. The communication unit 310 also receives the notification from the service provider's terminal 20 as to whether the service provider S has responded to the recruitment of the service provider. In addition, the communication unit 310 may receive from the service provider's terminal 20, the positional information of the candidate for the service provider, the information about the passenger and freight integrated mobile body M2 which the candidate for the service provider is on or will get on, and the like.

The communication unit 310 may also accept a request for the delivery or collection of the package L (hereinafter “delivery request”) by communicating with an information processing terminal used by the client R or an external terminal installed in a store or the like. The delivery request may include various requests including the delivery slot of the package L, the pick-up position of the package L, and the like.

### (Storage Unit)

The storage unit 320 holds software and various kinds of data. For example, the storage unit 320 stores therein information about the delivery person D. The information about the delivery person D may include, for example, basic information of the delivery person D (name, e-mail address, phone number, etc. of the delivery person D), delivery person ID that is identification information of the delivery person D, current positional information, a current delivery area, mobile body type identification information, delivery history information, etc., or may include a delivery company name and delivery company identification information. However, the information about the delivery person D is not limited to these items.

The storage unit 320 also stores information about the candidate for the service provider therein. The information about the candidate for the service provider includes, for example, the name of the candidate for the service provider, the name of the candidate for the service provider in the service, service provider ID, which is identification information of the candidate for the service provider, e-mail address, phone number, gender, age, and external application account information. However, the information about the candidate for the service provider is not limited to these items.

The storage unit 320 may also store therein the information about the service provision of the candidate for the service provider by linking such information to the service provider identification information, such as the service provider ID. The information about the service provision includes, for example, information about the status of participation in a predetermined training session related to the means of picking up the package L, the desired service provision area, identification card information (including driver's license information), transfer account information, service provision history information, and the like. The predetermined training session related to the means of picking up the package L is, for example, a training session to load the package L onto an unmanned vehicle.

The storage unit 320 may also store therein the service name, service identification information, stop route information, arrival time and departure time at each stop position, and other information for each service of the passenger and freight integrated mobile body M2 that operates on a regular schedule.

### (Control Unit)

The control unit 330 controls the overall operation of the server 30. The control unit 330, for example, controls to cause the communication unit 310 to transmit to the service provider's terminal 20, the notification of the recruitment of the service provider generated by the notification generation unit 350.

Moreover provided is a function to set the candidate for the service provider as the service provider S when the candidate for the service provider responds to the recruitment that is transmitted from the service provider's terminal 20 used by the candidate for the service provider. For example, upon the notification to the communication unit 310 that the candidate for the service provider responds to the recruitment, the control unit 330 sets the candidate for the service provider as the service provider s.

The control unit 330 generates instruction information, which is information to instruct the delivery person D to handle the package L, based on whether the candidate for the service provider has responded to the recruitment of the service provider. For example, in the case where the candidate for the service provider does not respond to the recruitment of the service provider, the instruction information may be information to instruct the delivery person D to perform the service that the service provider S would be responsible for if the candidate for the service provider responded to such recruitment. For example, the instruction information may be information that instructs to get on the passenger and freight integrated mobile body M2 together with the package L, or information that instructs to unload the package L from the passenger and freight integrated mobile body M2.

If the control unit 330 is not notified that the candidate for the service provider responds to the recruitment within a certain period of time after the communication unit 310 transmits the notification of the recruitment, it may be determined that the candidate for the service provider does not respond to the recruitment of the service provider.

Upon the transmission of the service provider setting request from the delivery person's terminal 10 to the communication unit 310, the service number of the passenger and freight integrated mobile body M2 that delivers the package L may be determined based on the designation of the service number included in the service provider setting request. The control unit 330 may also determine the service number of the passenger and freight integrated mobile body M2 that delivers the package L on the basis of the positional information of the delivery person's terminal 10. Specifically, the control unit 330 may calculate the time when the delivery person D arrives at the departure point DP of the passenger and freight integrated mobile body M2 on the basis of the position of the delivery person's terminal 10 and the departure point DP of the passenger and freight integrated mobile body M2. In that case, the control unit 330 may determine to deliver the package L on the mobile body departing from that departure point DP at the earliest time after that time. The control unit 330 may also determine the time at which the service provider S should provide the service on the basis of the determination of the service number of the passenger and freight integrated mobile body M2 that delivers the package L.

The control unit 330 may also have a function of generating a delivery plan related to the delivery of the package L upon the reception of the delivery request of the package L by the communication unit 310. For example, when the communication unit 310 receives the delivery request from the client R, the control unit 330 may generate the delivery plan on the basis of the delivery request. The control unit 330 may re-generate the delivery plan on the basis of whether the candidate for the service provider has responded to the recruitment of the service provider. The control unit 330 may determine the time when the service provider S should provide the service when the delivery slot of the delivery person D, the unmanned vehicle, or the like is determined regarding the package L, or on the contrary, may determine the delivery slot of the delivery person D, the unmanned vehicle, or the like when the service provider S is determined.

### (Candidate Determination Unit)

The candidate determination unit 340 has a function of determining the candidate for the service provider who is presumed to be able to provide services related to the delivery of the package L by the passenger and freight integrated mobile body M2 to be the candidate for the service provider related to the delivery of the package L. For example, if the delivery means of the package L includes the passenger and freight integrated mobile body M2, the candidate determination unit 340 determines the candidate for the service provider related to the delivery of the package L from among the candidates of the service provider.

The candidate determination unit 340 may determine the candidate for the service provider related to the delivery of the package L according to the positional information of the candidate for the service provider that is transmitted from the service provider's terminal 20 by the unit 310.

The candidate determination unit 340 may also determine the candidate for the service provider related to the delivery of the package L on the basis of the information about the passenger and freight integrated mobile body M2 which the candidate for the service provider is on. For example, the candidate determination unit 340 may determine the candidate for the service provider who is on the passenger and freight integrated mobile body M2 that delivers the package L to be the candidate for the service provider related to the delivery of the package L. Note that the passenger and freight integrated mobile body M2 which the candidate for the service provider is on may be presumed by the control unit 330 on the basis of the positional information of the candidate for the service provider, may be set arbitrarily by the input operation on the application when, for example, the candidate for the service provider gets on the passenger and freight integrated mobile body M2, or may be set in such a way that when the candidate for the service provider searches for the route on the application, the search result information is acquired.

The candidate determination unit 340 may also determine the candidate for the service provider who is scheduled to get on the passenger and freight integrated mobile body M2 that delivers the package L to be the candidate for the service provider related to the package L. When the candidate for the service provider who is on or is scheduled to get on the passenger and freight integrated mobile body M2 that delivers the package L is determined to be the candidate for the service provider related to the delivery of the package L, the candidate for the service provider can examine whether to be in charge of the service on the way to the destination after checking the notification of the recruitment. Note that the passenger and freight integrated mobile body M2 which the candidate for the service provider is scheduled to get on may be presumed by the control unit 330 on the basis of the positional information of the candidate for the service provider, may be set arbitrarily by the input operation on the application when, for example, the candidate for the service provider determines to get on the passenger and freight integrated mobile body M2, or may be set in such a way that when the candidate for the service provider searches for the route on the application, the search result information is acquired. In other words, this structure improves the convenience for the candidate for the service provider because it is possible to transmit the notification of the recruitment of the service that is easy for the candidate for the service provider to provide.

The candidate determination unit 340 may also determine a plurality of the candidates for the service provider. In such a case, the communication unit 310 may transmit the notification of the recruitment of the service provider to a plurality of the service provider's terminals 20 that are used by the respective determined candidates for the service provider. The control unit 330 may set the candidate for the service provider who uses the service provider's terminal 20 that transmitted the notification to respond to the recruitment first as the service provider S. The communication unit 310 may also transmit the notification of the recruitment of the service provider to one or more candidates for the service provider among the determined candidates for the service provider. At this time, in the case where the candidate for the service provider notified of the recruitment of the service provider does not respond to the recruitment, the control unit 330 may control the communication unit 310 to notify another candidate for the service provider who is different from the candidate for the service provider of the recruitment of the service provider.

### (Notification Generation Unit)

The notification generation unit 350 has a function of generating the notification of the recruitment of the service provider. The notification of the recruitment generated by the notification generation unit 350 is transmitted to the service provider's terminal 20 by the communication unit 310 in accordance with the control of the control unit 330. The recruitment of the service provider includes information such as the content of the service that the service provider will be in charge of, the location where the service provider is in charge of the service, and the time at which the service provider is in charge of the service. The content of the service for which the notification of the recruitment of the service provider is generated by the notification generation unit 350 may be the content of the service that the delivery person D hopes to be provided by the service provider and that is included in the service provider setting request transmitted from the delivery person's terminal 10. The content of the service for which the notification of the recruitment of the service provider is generated by the notification generation unit 350 may be the content in accordance with the delivery plan related to the delivery of the package L.

The notification generation unit 350 may also generate the notification of the recruitment of the service provider in charge of receiving the package L from the delivery person D and loading the package L into the passenger and freight integrated mobile body M2. The loading of the package L into the passenger and freight integrated mobile body M2 may be the accommodation in an accommodation box (housing unit) installed in the passenger and freight integrated mobile body M2. The accommodation box may be equipped with an authentication function so that only authenticated persons can receive the accommodated package L, or authentication information (e.g., authentication code) may be transmitted to the delivery person's terminal of the delivery person D or the service provider's terminal of the service provider S who receives the package when the accommodating operation of the package L is performed.

When the package L is accommodated and delivered in the accommodation box, the package L can be delivered more efficiently because the package L can be delivered without the necessity of the delivery person D and the service provider S getting on the passenger and freight integrated mobile body M2.

The notification generation unit 350 may also generate the notification of the recruitment of the service provider in charge of temporarily receiving the package L inside the passenger and freight integrated mobile body M2. The temporarily receiving of the package L inside the passenger and freight integrated mobile body M2 may be temporarily receiving from the delivery person D, or from the service provider S who is different from the service provider S in charge of that service. The temporarily receiving of the package L inside the passenger and freight integrated mobile body M2 may be receiving of the package L loaded in the passenger and freight integrated mobile body M2 by accommodation in the accommodation box or other means.

The notification generation unit 350 may generate the notification of the recruitment of the service provider in charge of the delivery of the package L to the service provider S or the delivery person D who is different from the service provider S in charge of the service or different from the delivery person D inside the passenger and freight integrated mobile body M2.

The notification generation unit 350 may also generate the notification of the recruitment of the service provider in charge of the delivery of the package L inside the passenger and freight integrated mobile body M2. The delivery of the package L inside the passenger and freight integrated mobile body M2 may be the delivery to the delivery person D, or to the service provider S that is different from the service provider S in charge of that service.

For example, the notification generation unit 350 may generate the notification of the recruitment of the service provider in charge of temporarily receiving the package L delivered by the passenger and freight integrated mobile body M2 outside the passenger and freight integrated mobile body M2. The temporarily receiving outside the passenger and freight integrated mobile body M2 may be the temporarily receiving from the delivery person D or the service provider S, or from an indoor or outdoor delivery box, etc., that can accommodate the package L. The package L may be received in such a way that the package L is unloaded from the unmanned vehicle that has delivered the package L. The notification generation unit 350 may generate the notification of the recruitment of the service provider in charge of the service and also in charge of the delivery of the package L by getting on the passenger and freight integrated mobile body M2.

The notification generation unit 350 may also generate the notification of the recruitment of the service provider in charge of temporarily receiving the package L from the delivery person D or the service provider S inside the passenger and freight integrated mobile body M2. In this case, the notification generation unit 350 may generate the notification of the recruitment of the service provider, including standing by at the arrival point AP by the expected arrival time of the passenger and freight integrated mobile body M2.

The notification generation unit 350 may also generate the notification of the recruitment of the service provider to get on the passenger and freight integrated mobile body M2 and take charge of the various services described above. In this case, the notification generation unit 350 generates the notification of the recruitment of the service provider, including the position and time of getting on the passenger and freight integrated mobile body M2. The position at which the service provider S gets on the passenger and freight integrated mobile body M2 may be the position at which the various services described above are performed, or may be a position at which the service provider S can get on the passenger and freight integrated mobile body M2 before the passenger and freight integrated mobile body M2 arrives at the position at which the service is performed.

In addition to the services described above, the notification generation unit 350 may also recruit additional services to handle the package L before or after the delivery in the passenger and freight integrated mobile body M2. For example, the notification generation unit 350 may generate the notification of the recruitment of the service provider in charge of packing the package L before the delivery by the passenger and freight integrated mobile body M2 and unpacking after the delivery by the passenger and freight integrated mobile body M2. The notification generation unit 350 may also generate the notification of the recruitment of the service provider in charge of unloading the package L from the unmanned vehicle before the delivery by the passenger and freight integrated mobile body M2 or loading the package L into the unmanned vehicle after the delivery.

The notification generation unit 350 may also generate the notification of the recruitment of the service provider in charge of the delivery of the package L to the client R after the delivery by the passenger and freight integrated mobile body M2. The delivery to the client R may be the delivery to the home of the client R or the delivery of the package L to the delivery point MP. The notification generation unit 350 may also generate the notification of the recruitment of the service provider in charge of delivery of the package L to the delivery person D or the service provider S who is different from the service provider S in charge of that service after the delivery by the passenger and freight integrated mobile body M2. The notification generation unit 350 may also generate the notification of the recruitment of the service provider in charge of accommodating the package L in the delivery box or the like installed indoors or outdoors, where the package L can be accommodated, after the delivery by the passenger and freight integrated mobile body M2.

The various notifications of the recruitment of the service provider generated by the notification generation unit 350 regarding the delivery of the package L have been described. The notification generation unit 350 generates the notification of the recruitment of the service provider in charge of at least any of the services related to the various notifications of the recruitment of the service provider described above. The notification generation unit 350 may generate the notification of the recruitment of the service provider in charge of some of the services collectively. The notification generation unit 350 may also generate the notifications of the recruitment of the service providers in charge of services with different contents with respect to one package L. In that case, the candidate determination unit 340 may determine the candidate for the service provider for each of the notifications of the recruitment of the service providers. The delivery person D may be notified of the instruction information corresponding to the status of the application for the recruitment content. In addition, in a case where after the notification of the recruitment of one service provider (for example, the recruitment of a series of services including receiving the package from the delivery person D at the passenger and freight integrated mobile body M2 at the departure point DP, getting off at the arrival point AP, and delivering the package to the delivery point) is generated, it is determined that there is no service provider who responds to the recruitment, the notifications of the recruitment of two or more service providers (for example, the recruitment of a series of separated services including first recruitment of the service of receiving the package from the delivery person D at the passenger and freight integrated mobile body M2 at the departure point DP and second recruitment of delivering the package from the service provider who is in the passenger and freight integrated mobile body M2 at the arrival point AP to the delivery point) may be re-generated for the delivery route of the same package. In the case of recruiting two or more service providers in this way, the instruction information to notify the delivery person D may be generated in accordance with the application status (for example, in the case where the first recruitment and the second recruitment are applied, the instruction information to instruct the delivery person D to pass the package to the service provider S at the departure point DP is generated, in the case where only the first recruitment is applied, the instruction information to instruct the delivery person D to pass the package to the service provider S at the departure point DP is generated and the instruction information to instruct another delivery person to receive the package from the service provider S at the arrival point AP is generated, and in the case where only the second recruitment is applied, the instruction information to instruct the delivery person D to get on the passenger and freight integrated mobile body M2 at the departure point DP and pass the package to the service provider S at the arrival point AP is generated, and so on).

As described above, the notification generation unit 350 can generate the notifications of the recruitment of various kinds of service providers. According to such a structure, it is possible to generate the notifications of the recruitment of the service providers in accordance with the situation of the delivery person D, thus improving the efficiency of the delivery of the package L.

The notification generation unit 350 may also generate the notification of the recruitment of the service provider that includes reward information. The reward information is information about the reward that the service provider S can receive for providing the services for which the service provider is recruited. The reward may be money, a service, or points of monetary value, etc. The content of the reward may be determined by the delivery person D who uses the delivery person's terminal 10 that transmits the provider setting request, or may be a predetermined content.

The example of the functional configuration according to the embodiment of the present invention has been described above. Subsequently, an example of operation processing according to the present embodiment is described.

### 3. Example of Operation Processing in Present Embodiment

Here, the delivery person D, the candidate for the service provider, and the service provider S who are provided by the present information processing system access the server 30 using an application (including a web browser) or the like, and if they use the service for the first time, they may acquire their accounts through a registration process. After the user acquires the account or if the user already has an account, the user may be able to use the service by logging in after prescribed authentication, for example, by entering the service provider ID or the delivery person ID and a password.

Instead of the account, a unique application ID related to the application downloaded on the delivery person's terminal 10 or the service provider's terminal 20 may be used as the service provider ID or the delivery person ID to enable the use. After this login authentication, the service use is initiated via the application (including web browser), etc.

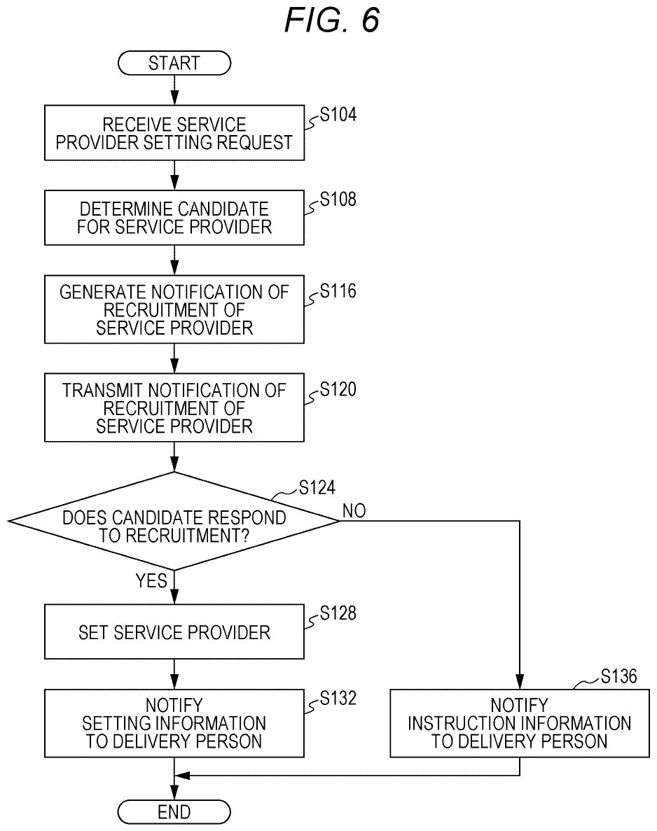

FIG. 6 is an explanatory diagram for describing an example of the procedure of the operation processing by the server 30 according to the present embodiment. First, the communication unit 310 receives the service provider setting request related to the delivery of the package L from the delivery person's terminal 10 (S104). The candidate determination unit 340 determines the candidate for the service provider in response to the service provider setting request (S108).

The notification generation unit 350 then generates the notification of the recruitment of the service provider in response to the service provider setting request (S116).

The communication unit 310 then transmits the notification of the recruitment of the service provider generated by the notification generation unit 350 to the service provider's terminal 20 used by the candidate for the service provider determined by the candidate determination unit 340 (S120).

Then, the control unit 330 determines whether the candidate for the service provider responds to the recruitment on the basis of the notification received from the service provider's terminal 20 by the communication unit 310 as to whether the candidate for the service provider responds to the recruitment (S124). If it is determined that the candidate for the service provider responds to the recruitment (Yes at S124), the process advances to S128; if it is determined that the candidate for the service provider does not respond to the recruitment (No at S124), the process advances to S136.

If it is determined that the candidate for the service provider responds to the recruitment (Yes at S124), the control unit 330 sets the candidate for the service provider who has responded to the recruitment as the service provider S (S128). The communication unit 310 then notifies the delivery person D of the setting information regarding the setting of the service provider by the control unit 330, and the server 30 terminates the operation (S132).

On the other hand, if it is determined that the candidate for the service provider does not respond to the recruitment (No at S124), the communication unit 310 notifies the delivery person D of the instruction information generated by the control unit 330, and the server 30 terminates the operation (S136).

### 4. Example of Hardware Configuration

The information processing described above is achieved through cooperation between software and hardware of the server 30 to be described below. The hardware configuration to be described below is also applicable to the delivery person's terminal 10 and the service provider's terminal 20 to be described below.

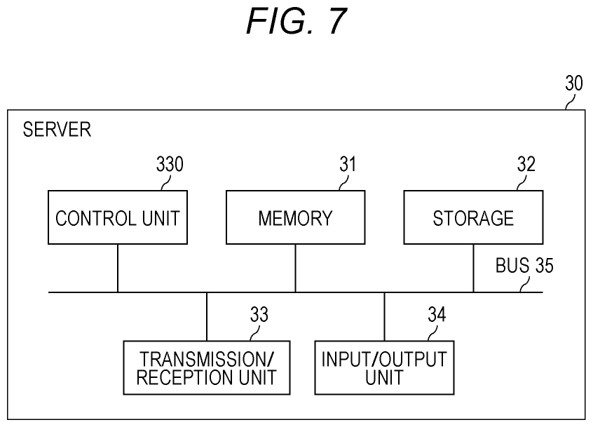

FIG. 7 is an explanatory diagram for describing an example of the hardware configuration of the server 30 according to the present embodiment. The server 30 includes the control unit 330, a memory 31, a storage 32, a transmission/reception unit 33, an input/output unit 34, and the like, which are electrically connected to each other through a bus 35 as illustrated in FIG. 7, for example.

The control unit 330 is an arithmetic unit that controls the overall operation of the server 30, controls the transmission and reception of data between the components, performs information processing necessary for the application execution and the authentication process, and so on. For example, the control unit 330 is a central processing unit (CPU) and/or a graphics processing unit (GPU), which executes programs for this system stored in the storage 32 and developed in the memory 31, for example, to perform various kinds of information processing as described above.

The memory 31 includes a main memory, which is composed of a volatile storage device such as dynamic random access memory (DRAM), and a secondary memory, which is composed of a non-volatile storage device such as a flash memory or a hard disc drive (HDD). The memory 31 is used as a work area for the control unit 330, for example, and also stores therein the basic input/output system (BIOS), which is executed when the server 30 is started, various kinds of setting information, and the like.

The storage 32 stores various programs such as application programs. The database storing the data used for each process may be constructed in the storage 32.

The transmission/reception unit 33 connects the server 30 to a network and/or a blockchain network. The transmission/reception unit 33 may include a short-range communication interface such as Bluetooth (registered trademark) and Bluetooth low energy (BLE).

The input/output unit 34 corresponds to an information input device such as a keyboard, a microphone, or a mouse, or an output device such as a display or a speaker.

The bus 35 is commonly connected to each of the above-described components and transmits, for example, address signals, data signals, and various control signals.

### 4. Supplement

The preferred embodiments of the present invention have been described above in detail with reference to the accompanying drawings; however, the present invention is not limited to such examples. It is readily apparent to those having ordinary knowledge and skilled in the art to which the present invention belongs that various modifications and substitutions can be made without departing from the technical spirit and scope of the appended claims, and that those naturally fall within the technical scope of the present invention.

In the example described in the above embodiment, the server 30 recruits the service provider who is in charge of the delivery of the package L by the passenger and freight integrated mobile body M2; however, the delivery means of the package L is not limited to the passenger and freight integrated mobile body M2. In another example, the delivery means of the package L may be a manned mobile body used as the delivery means of the package L by the delivery person D. In this case, for example, the notification generation unit 350 may generate the notification of the recruitment of the service provider in charge of receiving temporarily the package L delivered by the manned mobile body outside the manned mobile body, passing the package L to the delivery person D or the service provider S who is inside the manned mobile body, or receiving temporarily the package L from the delivery person D or the service provider S who is inside the manned mobile body.

The delivery means of the package L may be the unmanned vehicle. In this case, the notification generation unit 350 may, for example, generate the notification of the recruitment of the service provider in charge of temporarily receiving the package L delivered by the unmanned vehicle outside the unmanned vehicle, loading the package L into the unmanned vehicle, or temporarily receiving the package L loaded in the unmanned vehicle.

In the example described in the above embodiment, the service provider S is a gig worker in charge of a single service. However, the service provider S may be a specific person such as a family member or friend of the client R, a manager of the departure and arrival point of the unmanned vehicle, or an organizer of a neighborhood association. In this case, the storage unit 320 may receive from the information processing terminal used by the client R, the information designating a specific person as the candidate for the service provider. The candidate determination unit 340 may then determine the specific person to be the candidate for the service provider related to the delivery of the package L to be delivered to the client R.

In the example described in the above embodiment, the service provider S is recruited and the delivery to the recipient is performed through the service provider; however, in the passenger and freight integrated mobile body M2, the recipient may get on the mobile body as a passenger. Therefore, as for the content related to the receiving (receiving method) in the recruitment content for the service provider S described above, the recipient's terminal may be notified of whether the execution by the recipient is possible (that is to say, notification to check whether the recipient can receive the package inside the passenger and freight integrated mobile body M2 or whether the recipient can receive the package from the passenger and freight integrated mobile body M2) and if the recipient performs the confirming operation expressing that the package can be received with respect to the notification, the recruitment of the service provider S is unnecessary. The notification may be a notification for checking the receiving method selected by the delivery person D for the predetermined passenger and freight integrated mobile body M2, or may be a notification allowing the recipient to select the receiving method for the predetermined passenger and freight integrated mobile body M2. On the contrary, the delivery person's terminal may be notified of whether the delivery person D can handle the receiving method designated by the recipient alone or in combination of the recruitment of the service provider S.

In addition, it is also possible to create a computer program to make the hardware such as a CPU, a ROM, and a RAM incorporated in the server 30 achieve the functions equivalent to the respective structures of the server 30 describe above.

### REFERENCE SIGNS LIST

10 Delivery person's terminal
20 Service provider's terminal
30 Server
50 Network
110 Communication unit
130 Control unit
140 Operation display unit
210 Communication unit
230 Control unit
240 Operation display unit
310 Communication unit
320 Storage unit
330 Control unit
340 Candidate determination unit
350 Notification generation unit

1. An information processing system comprising a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

2. The information processing system according to claim 1, further comprising a control unit that sets the candidate for the service provider, as the service provider when the candidate for the service provider responds to the recruitment of the service provider, wherein
the communication unit notifies a delivery person's terminal used by the delivery person of setting information about setting of the service provider.

3. The information processing system according to claim 2, wherein
the control unit generates instruction information that is information to instruct the delivery person to handle the package, based on whether the candidate for the service provider responds to the recruitment of the service provider, and
the communication unit notifies the delivery person's terminal of the instruction information.

4. The information processing system according to claim 3, wherein the instruction information includes information to instruct the delivery person to get on the mobile body together with the package.

5. The information processing system according to claim 3, wherein the instruction information includes information to instruct the delivery person to unload the package from the mobile body.

6. The information processing system according to claim 2, wherein the communication unit receives a service provider setting request that is a notification to request setting of the service provider from the delivery person's terminal.

7. The information processing system according to claim 2, wherein the mobile body is a mobile body that operates on a regular schedule.

8. The information processing system according to claim 7, wherein the control unit determines a time when the service provider provides a service, based on a determination of a service number of the mobile body that delivers the package.

9. The information processing system according to claim 7, wherein the communication unit receives from the delivery person's terminal, information to instruct the service number of the mobile body that delivers the package.

10. The information processing system according to claim 1, wherein the communication unit issues notification of the recruitment of the service provider in charge of temporarily receiving the package that is delivered by the mobile body outside the mobile body and in charge of delivering the package by getting on the mobile body.

11. The information processing system according to claim 10, wherein the communication unit issues notification of the recruitment of the service provider in charge of temporarily receiving the package that is delivered by the mobile body outside the mobile body and in charge of loading the package into an unmanned vehicle after the delivery by the mobile body.

12. The information processing system according to claim 1, wherein the package loaded in the mobile body is accommodated in an accommodation box installed in the mobile body.

13. The information processing system according to claim 1, wherein the communication unit issues notification of the recruitment of the service provider in charge of temporarily receiving the package from the delivery person or the service provider inside the mobile body or temporarily receiving the package loaded in the mobile body by getting on the mobile body.

14. The information processing system according to claim 1, wherein the communication unit notifies the service provider's terminal used by the candidate for the service provider who is on the mobile body, of the recruitment of the service provider in charge of at least any of temporarily receiving the package from the delivery person inside the mobile body and temporarily receiving the package loaded in the mobile body.

15. The information processing system according to claim 1, wherein the communication unit issues notification of the recruitment of the service provider in charge of at least any of temporarily receiving the package outside the mobile body, temporarily receiving the package from the delivery person inside the mobile body, temporarily receiving the package loaded in the mobile body, and temporarily receiving the package from the delivery person who is inside the mobile body, and in charge of unloading the package from the mobile body.

16. The information processing system according to claim 15, wherein the communication unit issues notification of the recruitment of the service provider in charge of unloading the package from the mobile body and in charge of loading the package into an unmanned vehicle.

17. An information processing device including a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

18. An information processing method to be performed by a computer, the information processing method including notifying a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.

19. A program that causes a computer to function as a communication unit that notifies a service provider's terminal used by a candidate for a service provider, of recruitment of the service provider in charge of at least any of temporarily receiving a package delivered by a mobile body that performs transportation in a passenger and freight integrated way outside the mobile body, passing the package to a delivery person or the service provider who is inside the mobile body, loading the package into the mobile body, passing the package inside the mobile body, temporarily receiving the package inside the mobile body, and temporarily receiving the package from the delivery person or the service provider who is inside the mobile body.
